(19) United States
(12) Patent Application Publication
(10) Pub. No.: US 2012/0245496 A1
(43) Pub. Date: Sep. 27, 2012

(54) CHAIR-TYPE MASSAGING MACHINE PROVIDED WITH LEG MASSAGING DEVICE

(76) Inventors: Tetsuya Ishikawa, Higashi-Osaka-shi (JP); Mikitaka Aoki, Higashi-Osaka-shi (JP); Shinsaku Shimizu, Higashi-Osaka-shi (JP); Koichi Numata, Higashi-Osaka-shi (JP)

(21) Appl. No.: 13/514,869

(22) PCT Filed: Aug. 26, 2010
(86) PCT No.: PCT/JP2010/064450

§ 371 Date: Jun. 8, 2012

(30) Foreign Application Priority Data
Dec. 9, 2009 (JP) 2009-279348

(51) Int. Cl. A61H 7/00

(52) U.S. Cl. 601/98

(57) ABSTRACT

In a chair-type massaging machine, when using a leg massaging device or when used as merely a chair or a sofa, it is made possible for a user to take a relaxed posture such as stretching legs forward. The leg massaging device provided in the chair-type massaging machine of the present invention is provided with an advancing and retreating mechanism. The advancing and retreating mechanism allows the leg massaging device to advance and retreat between a zero position in which the treating surface of the leg massaging device hangs down at the front end of the seat section and a second massaging position in which the treating surface is kept substantially horizontal in a massaging mode time.

### TECHNICAL FIELD

The present invention relates to a chair-type massaging machine provided with a leg massaging device.

### BACKGROUND ART

As a chair-type massaging machine provided with a leg massaging device, there is disclosed in, for example, Patent Document 1.

This chair-type massaging machine includes a backrest part at a rear portion of a seat section and a leg massaging device at a front portion thereof, respectively, wherein the backrest part is provided with a massaging mechanism for massaging a back region of a user and the leg massaging device is equipped with a built-in lower limb massaging mechanism for massaging lower limbs of the user. Further, the backrest part is movable in a manner of reclining back and forth and the leg massaging device is swingably provided in front of the seat section via a supporting member.

Such a chair-type massaging machine is not only used for massaging but also used merely as a chair in many cases. Particularly, in this kind of the chair-type massaging machine, a soft cushion is included in such as a seat section in many cases, and the backrest part has a reclining function so that the chair-type massaging machine is suited for use as a sofa.

Regarding the leg massaging device of Patent Document 1, however, since holding grooves are formed in the front thereof, lower limbs should be fitted into the holding grooves even in the case of using no massaging function, and this results in restriction of a free movement of the legs so that it becomes difficult to take an easy posture. Also, this becomes one factor of detracting an appearance of a chair.

Therefore, in order to avoid such disadvantages, the applicant of the present application has already developed a technique as disclosed in Patent Document 2.

This chair-type massaging machine includes a pushing/pulling mechanism capable moving a leg massaging device between a use position and a storage position located beneath a seat section, and this pushing/pulling mechanism includes guiderails provided on both sides of the chair-type massaging machine, pushing/pulling rods moving in and out along the guiderails and a carriage plate coupled to the pushing/pulling rods, so that the leg massaging device is pin-connected to the carriage plate.

Therefore, a front side (massaging surface) and a rear side (footrest surface) of the leg massaging device are made rotationally switchable while the leg massaging device is situated in the use position.

### PRIOR ART DOCUMENTS

### Patent Documents

Patent Document 1: Japanese Unexamined Patent Publication JP-A2002-238963

Patent Document 2: Japanese Unexamined Patent Publication JP-A2007-75590

### DISCLOSURE OF THE INVENTION

### Problems to be Solved by the Invention

However, in order to adopt a guiderail, it is required to form a smooth curve in the guiderail, and since a highly precise and careful machining are required in this point, there is one aspect that it is difficult to suppress a production cost.

Further, since the guiderail formed with a curve is partially accompanied by a large sliding resistance, a strong drive corresponding thereto is required while requiring a devise for suppressing drive noises and vibrations contrarily and, therefore, there has been room for improvement against such as increase of burdens in structure as well as weight.

In addition, as another requirement, there has been a desire for a user to take a relaxed posture such as stretching out legs forward (i.e., a posture with knees stretched as possible) when using the leg massaging device.

Also, when the leg massaging device is placed in front of the seat section, there has been a requirement that the position of the leg massaging device (a distance from the seat section) is desired to be adjusted to an optimum position suited to a height of the user. However, it is assumed that a drive structure is avoided from complication in order to satisfy these requirements.

Therefore, in consideration of the above problems, the present invention has an object to provide a chair-type massaging machine capable of collectively solving further simplification in structure, reduction in weight and cost, and the like. In addition, assuming that the drive structure is not complicated, the present invention has an object to provide a chair-type massaging machine allowing a user to take a relaxed posture such as stretching out legs forward when using the leg massaging device or using merely as a chair or a sofa and also allowing a positional adjustment of the leg massaging device corresponding to differences in height of users so as to enhance a sense of use.

### Means Adapted to Solve the Problems

In order to accomplish the object mentioned above, the following technical means is taken in the present invention. That is, a chair-type massaging machine provided with a leg massaging device according to the present invention includes: a seat section; a backrest part provided at a rear portion of the seat section; and the leg massaging device provided at the front portion of the seat section, wherein an advancing and retreating mechanism connected with the leg massaging device is provided beneath the seat section, wherein the advancing and retreating mechanism is configured to advance the leg massaging device positioned in a zeroth position where the leg massaging device is in a state of hanging down in front of the seat section to a first position where the leg massaging device is in a state of inclining obliquely downward in front of the seat section and further advance the leg massaging device positioned in the first position to a second position where the leg massaging device is moved to be protruded forward so as to be in a substantially horizontal state while being coplanar with a top surface in height of the seat section, and wherein the advancing and retreating mechanism lowers the leg massaging device positioned in the second position to return to the first position by retreat movement, and further lowers the leg massaging device positioned in the first position to return to the zeroth position.

In addition, the leg massaging device is provided with a supporting surface for supporting lower limbs of a user from a back side and a treating surface allowing to massage the lower limbs of the user so that the supporting surface and treating surface are located opposite in back-and-forth directions, and the supporting surface and treating surface are coupled to the advancing and retreating mechanism in a back-and-forth reversible state, and in a reclining mode in which the supporting surface of the leg massaging device is facing forward, the zeroth position is used as a stand-by position where the leg massaging device hangs down in a state that the lower limbs of the user are not supported, the first position is used as a first reclining position where the lower limbs of the user can be supported, and the second position is used as a second reclining position where the lower limbs of the user can be supported.

The leg massaging device is provided with a supporting surface for supporting lower limbs of a user from a back side and a treating surface allowing to massage the lower limbs of the user so that the supporting surface and treating surface are located opposite in back-and-forth directions, and the supporting surface and treating surface are coupled to the advancing and retreating mechanism in a back-and-forth reversible state, and in a massaging mode in which the treating surface of the leg massaging device is facing forward, the zeroth position is used as a zero position where the leg massaging device hangs down in a state that the lower limbs of the user can be massaged, the first position is used as a first massaging position where the lower limbs of the user can be massaged, and the second position is used as a second massaging position where the lower limbs of the user can be massaged.

Preferably, in the stand-by position and the zero position, the leg massaging device is held on the front portion of the seat section in a state that a lower end portion of the leg massaging device floats up from a floor surface.

Referring to a configuration in details of the chair-type massaging machine provided with the leg massaging device according to the present invention, the advancing and retreating mechanism includes: a supporting member for holding the leg massaging device; an expansion link having a proximal end side thereof provided at the front end portion of the seat section and coupled to a fixed pivot part pivotably about a lateral axis and a distal end side thereof attached to the supporting member so that the expansion link is extendable and contractable in a longitudinal direction; and a driving part adapted to provide the expansion link with a swing about the fixed pivot part.

In particular, the driving part includes: rail parts provide under the seat section with the longitudinal direction thereof directed back and forth; a back-and-forth moving part movable back and forth along the rail parts; and a prime mover mechanism adapted to provide the back-and-forth moving part with a back-and-forth driving force, wherein the back-and-forth moving part and the supporting member are coupled with each other with a pivotal fulcrum located beneath the fixed pivot part.

Further, the fixed pivot part is provided substantially coplanar in height with a top surface of the seat section, and the pivotal fulcrum is located in a position substantially vertically beneath the fixed pivot part in the stand-by position or the zero position.

Moreover, the rail parts are provided at both right and left sides under the seat section, and the back-and-forth moving part includes a pair of slider contacts engaged with the right and left rail parts and a connecting member for coupling between the pair of slider contacts, and the expansion link or the supporting member is respectively coupled to the front end portion of each of the slider contacts with the pivotal fulcrum.

Preferably, the expansion link of the advancing and retreating mechanism includes a link main body which is provided with the fixed pivot part at the proximal end thereof so as to be swingable and a slide link which is slidably held with respect to the link main body and fixed to the supporting member so as to have a structure extendable and contractable in the back and forth direction.

The expansion link is preferably configured that one of the link main body and the slide link thereof is configured as an external cylinder shaft, and the other is configured as an inner shaft which is internally fitted to the external cylinder shaft and is slidably movable in and out of the external cylinder shaft.

More preferably, the leg massaging device is equipped with a built-in lower limb massaging device, and the lower limb massaging device includes: a pair of right and left massaging members formed in a boots shape in a side view along the lower limbs continually ranging from calves to foot portions of the user and arranged so as to hold the lower limbs therein and directed to the treating surface side; a single rotation shaft provided in a manner of transversely penetrating the pair of massaging member; a driving part for rotating the rotation shaft; and a conversion part for converting a rotating force of the rotation shaft to a massaging operation performed by aid massaging members.

### EFFECTS OF THE INVENTION

According to the chair-type massaging machine according to the present invention, it is possible to collectively solve further simplification in structure, reduction in weight and cost, and the like. In addition, in the chair-type massaging machine according to the present invention, without any complication of the drive structure, a user can take a relaxed posture such as stretching out legs forward when using the same for massaging the legs with the leg massaging device or using the same merely as a chair or a sofa, and also it becomes possible to adjust a position of the leg massaging device corresponding to differences in height of users so as to be able to enhance a sense of use.

### BRIEF DESCRIPTION OF THE DRAWINGS

FIG. 1 is a perspective view showing a partially omitted leg massaging device of a chair-type massaging machine according to the present invention (stand-by position in a reclining mode).

FIG. 2 is a perspective view showing a partially omitted leg massaging device of the chair-type massaging machine according to the present invention (second reclining position in the reclining mode).

FIG. 3 is a side view showing a partially omitted leg massaging device of the chair-type massaging machine according to the present invention (stand-by position in a reclining mode).

FIG. 4 is a sideview showing a partially omitted leg massaging device of the chair-type massaging machine according to the present invention (first reclining position in the reclining mode).

FIG. 5 is a side view showing a partially omitted leg massaging device of the chair-type massaging machine according to the present invention (second reclining position in the reclining mode).

FIG. 6 is a perspective view showing a partially omitted leg massaging device of the chair-type massaging machine according to the present invention (zero position in a massaging mode).

FIG. 7 is a perspective view showing a partially omitted leg massaging device of the chair-type massaging machine according to the present invention (second massaging position in the massaging mode).

FIG. 8 is a side view showing a partially omitted leg massaging device of the chair-type massaging machine according to the present invention (zero position in the massaging mode).

FIG. 9 is a side view showing a partially omitted leg massaging device of the chair-type massaging machine according to the present invention (first massaging position in the massaging mode).

FIG. 10 is a side view showing a partially omitted leg massaging device of the chair-type massaging machine according to the present invention (second massaging position in the massaging mode).

FIG. 11 is a perspective view showing an outline of the chair-type massaging machine according to the present invention.

FIG. 12 is a perspective view showing one example of a lower limb massaging device adopted to the leg massaging device.

### BEST MODE FOR CARRYING OUT THE INVENTION

The following describes an embodiment of the present invention with reference to the drawings.

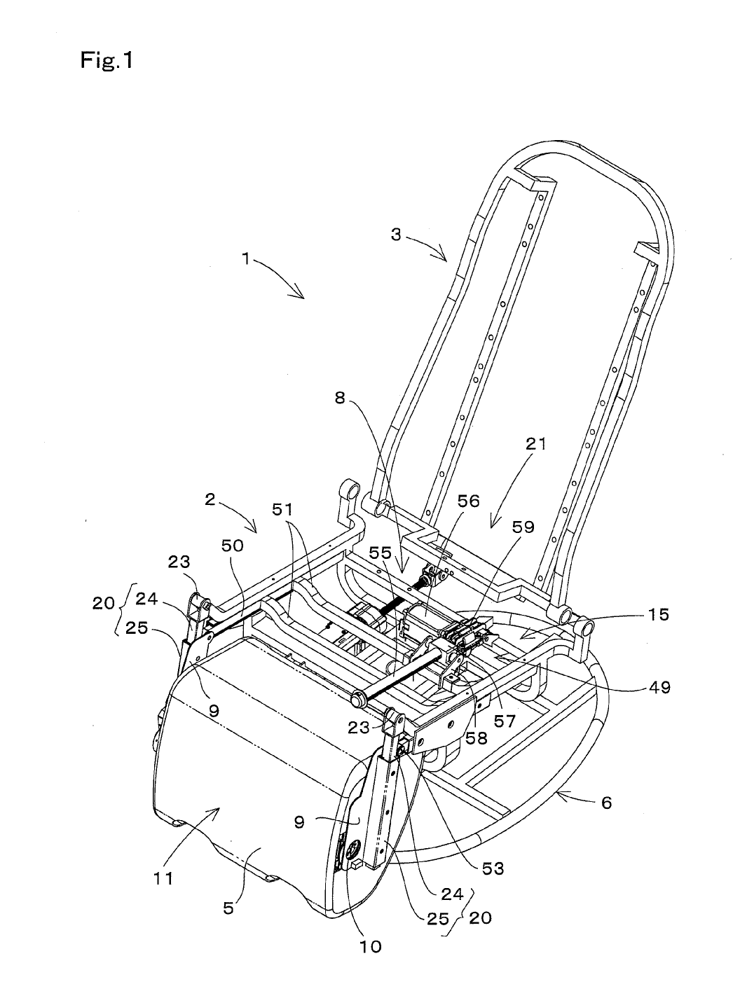

FIGS. 1 to 12 show one embodiment of a chair-type massaging machine 1 according to the present invention.

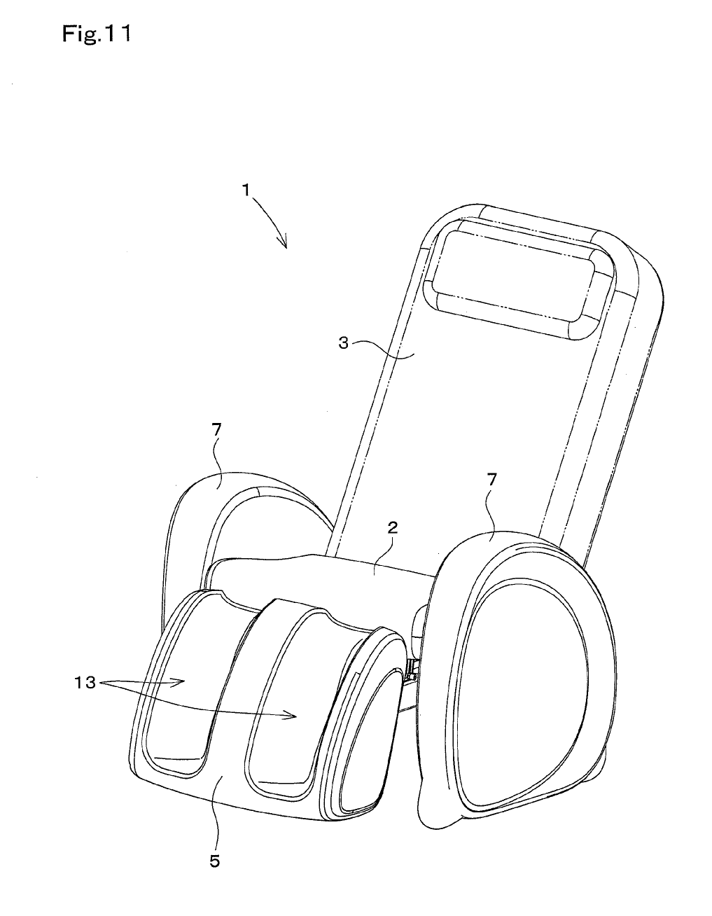

FIG. 11 shows an overall outline of the chair-type massaging machine 1, and as apparent from this drawing, the chair-type massaging machine 1 includes a seat section 2 and a backrest part 3 provided at a rear portion of this seat section 2. Also, at the front portion of the seat section 2, there is provided a leg massaging device 5 for massaging lower limbs of a user sitting on the seat section 2, and armrests 7 are provided in a manner of sandwiching both sides of the seat section 2 therebetween.

It is noted that, in the present specification, a part under a knee of a user is referred to as “lower limb”, wherein a part from the part under the knee to a malleolus (around ankles) is referred to as “calf”, and a part under the calf is referred to as “foot”.

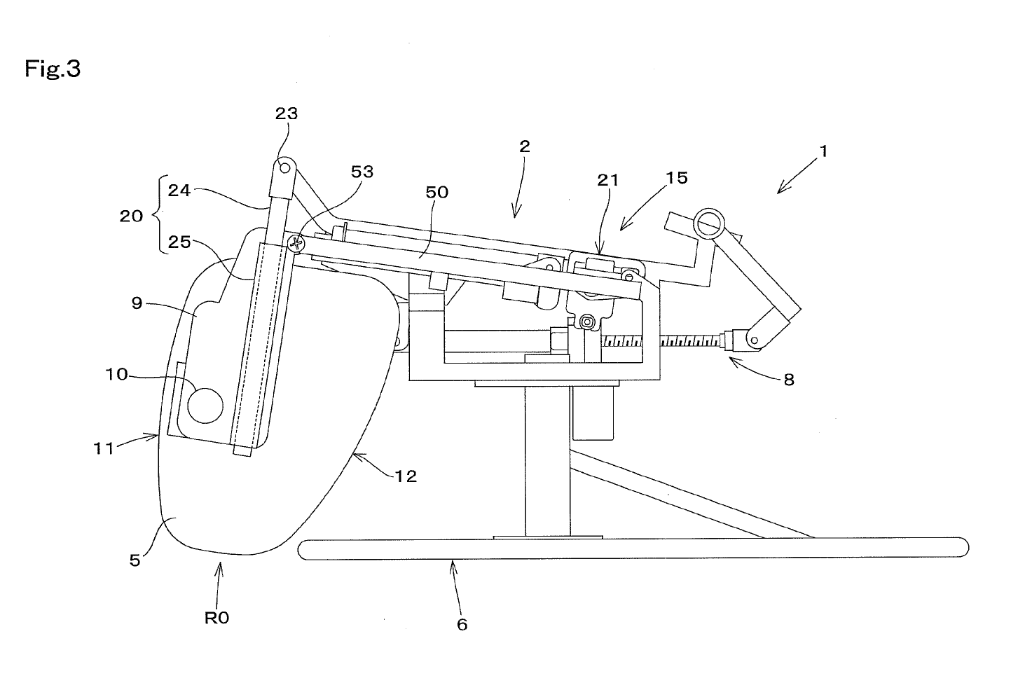

As to each drawing of FIGS. 3 to 5 and FIGS. 8 to 10, assuming that, a right and left direction thereof is referred to as “back-and-forth direction” in a practical device, and similarly a direction penetrating a page space of each drawing is referred to as “right and left direction” or “width direction” in the practical device, the description is continued. Also, a vertical direction of each drawing is referred to as “vertical direction” in the practical device. These directions correspond to those viewed by a user sitting on the chair-type massaging machine 1.

In FIGS. 1 to 10, in order to make it easy to see a lower part of the seat section 2, the seat section 2 and armrests 7 are omitted in the drawings, and the chair-type massaging machine 1 is shown while the backrest 3 is also partially or entirely omitted according to necessity.

The seat section 2 has a space enough to support a hip of a user from the lower part. A leg frame 6 is provided under the seat section 2 for installing the chair-type massaging machine 1 on a floor surface so that the seat section 2 is supported at a predetermined height by the leg frame 6. This leg frame 6 is hidden by the armrests 7 so as not to be visible from an outer appearance.

The lower end portion of the backrest 3 is pivoted in a state of being swingable back and forth with respect to the rear portion of the seat section 2 or the rear portion of the leg frame 6. This backrest 3 is made recliningable by a reclining mechanism 8 such as a linear actuator mechanism situated in the leg frame 6. Inside the backrest 3, a back massaging mechanism (not shown) is provided in a manner of being vertically movable for performing a massaging operation such as massaging and patting or vibrations.

The leg massaging device 5 provided at the front portion of the seat section 2 is formed in a box shape such as representing substantially a rectangular shape when seeing in front view and representing a rounded-like triangular or trapezoidal shape when seeing in side view.

This leg massaging device 5 is held in a manner of being sandwiched between tip end sides of supporting members 9 respectively provided at both right and left sides thereof and is rendered to be rotatable about a lateral axis. A proximal end side of the supporting member 9 is pivoted on the front portion of the seat section 2 on a pivotal fulcrum 53 in a manner of being pivotable about a lateral axis.

On the tip sides of the supporting members 9 provided in pair at both right and left sides, a pair of reversing devices 10 are provided for allowing the leg massaging device 5 to be reversible. By operating the reversing devices 10, a surface facing forward and a surface facing backward of the leg massaging device 5 can be replaced with each other. For example, the reversing device 10 can be configured by providing appropriately engaging/disengaging mechanisms at two positions 180° apart from each other in a circumferential direction or by providing a ratchet mechanism at a reversion central portion.

The leg massaging device 5 is provided with a supporting surface 11 on one surface side of the two surfaces replaced by the reversion about the lateral axis and a treating surface 12 on the other surface side thereof.

The supporting surface 11 is a surface adapted to be able to support lower limbs of a user from the back sides of the calves and is formed to be substantially flat. Preferably, it may be structured such that a cushion material such as sponge or urethane is loaded inside thereof and a surface thereof is covered with a cover material such as leather sheet or leather resistant to dirt and abrasion. This supporting surface 11 is used in a reclining mode to be described later. On the contrary, the treating surface 12 is a surface adapted to be able to massage lower limbs of a user and is formed with a pair of right and left holding grooves 13 allowing the lower limbs (right and left feet) of the user to be fitted therein. And a lower limb massaging device 14 for massaging a lower limb is built in an inner opposed surface of each of the holding grooves 13. This treating surface 12 is used in a massaging mode to be described later.

In addition, this lower limb massaging device 14 may adopt a configuration that provides a massage by laterally swinging a long plate member in a length-wise direction of a leg or may adopt a configuration that provides a massage with an air bag which is expanded and contracted by supplying and exhausting air. The lower limb massaging device 14 adopted in the present embodiment is described in detail in the last.

The leg massaging device 5 is configured that a state thereof is switchable between two modes. Specifically, it is switchable between a reclining mode for exerting convenience when used as merely a chair or a sofa and a massaging mode for exerting convenience when used as a device for undergoing a massage.

The massaging mode is referred to a state in which the treating surface 12 of the leg massaging device 5, i.e., a surface formed with a pair of right and left holding grooves 13 allowing the lower limbs (right and left feet) of a user to be fitted therein is rendered to face forward. In the massaging mode, a user sitting on the seat section 2 can massage the lower limbs.

The reclining mode is referred to a state in which the substantially flat supporting surface 11 of the leg massaging device 5, i.e., a surface which is allowed to support the lower limbs of a user from the back side is rendered to face forward. In the reclining mode, it becomes possible for a user sitting on the seat section 2 to leave the lower limbs on the supporting surface 11 so as to take a comfortable posture.

FIGS. 1 to 5 show the state of the leg massaging device 5 when in the reclining mode.

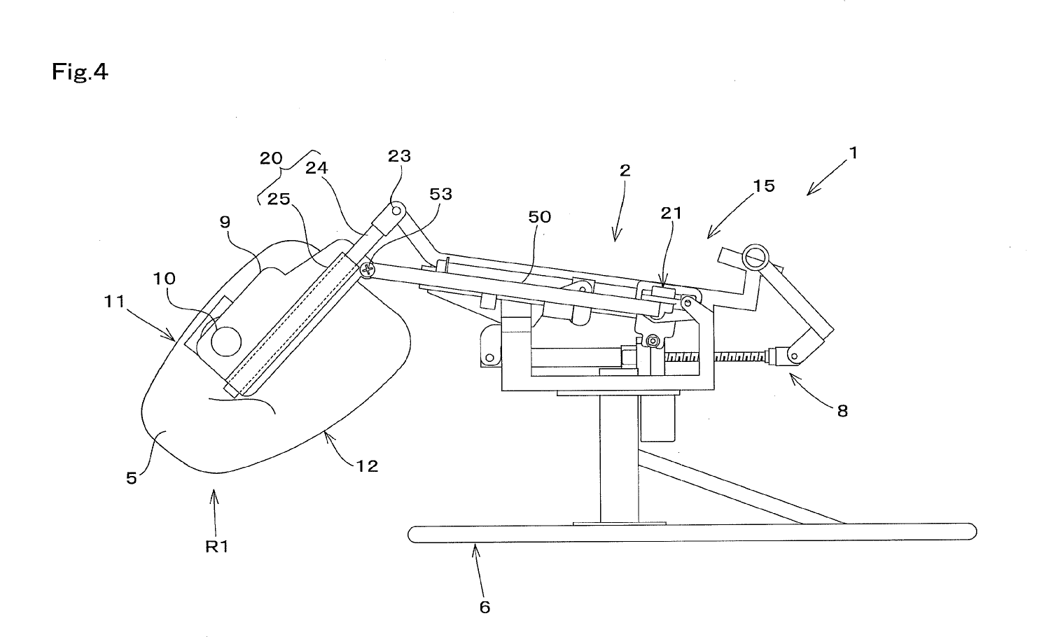

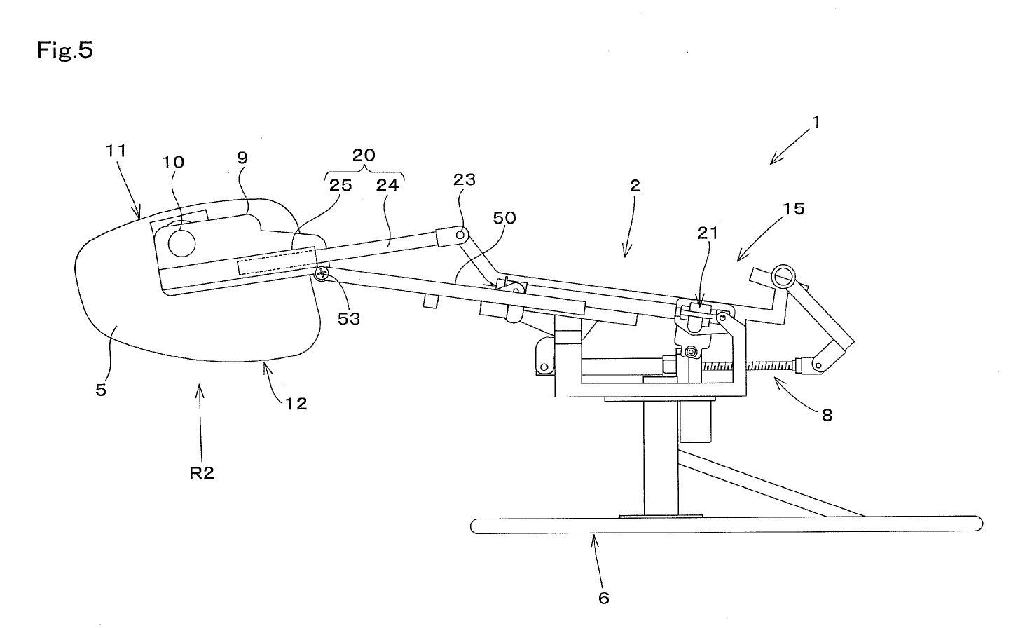

When in the reclining mode, the leg massaging device 5 can take: a stand-by position RO (zeroth position) in which the leg massaging device 5 hangs down in a state that the lower limbs of a user are not supported at the front end of the seat section as shown in FIG. 3; a first reclining position R1 (first position) in which the leg massaging device 5 is moved to a state of inclining obliquely downward in front of the seat section so as to support the lower limbs of a user as shown in FIG. 4; and a second reclining position R2 (second position) in which the leg massaging device 5 is moved to a substantially horizontal state of being coplanar with a top surface in height of the seat section in front of the seat section and thereafter further advanced to support the lower limbs of a user as shown in FIG. 5. The leg massaging device 5 is made movable among the respective positions (R0 to R2).

The first reclining position R1 is set as an optional position (optional floating height from a floor surface) between the stand-by position RO and the second reclining position R2 by a user as occasion requires, or to be initialized by a user, an installer, a manager and the like in a stage of starting usage or a stage of shipping from a factory.

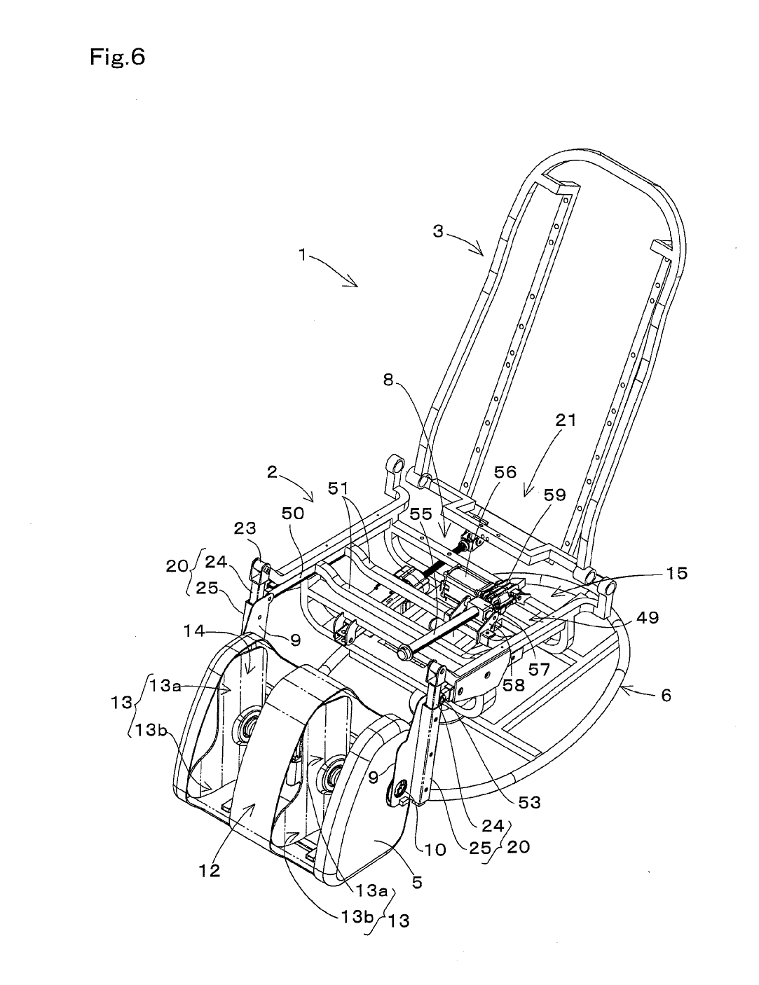

FIGS. 6 to 10 show the state of the leg massaging device 5 when in the massaging mode.

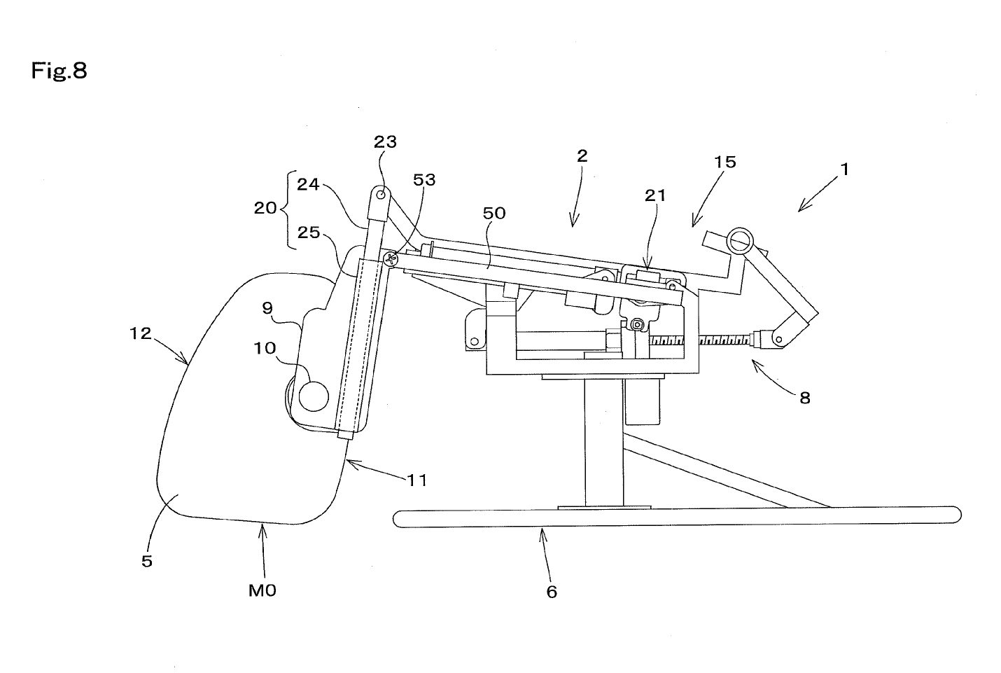

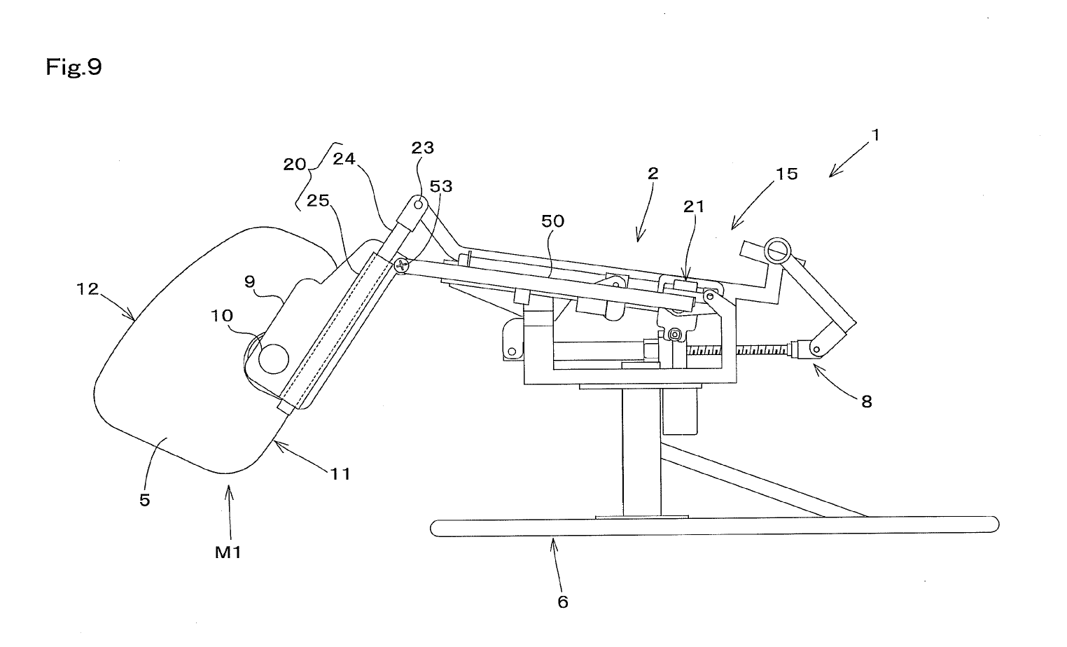

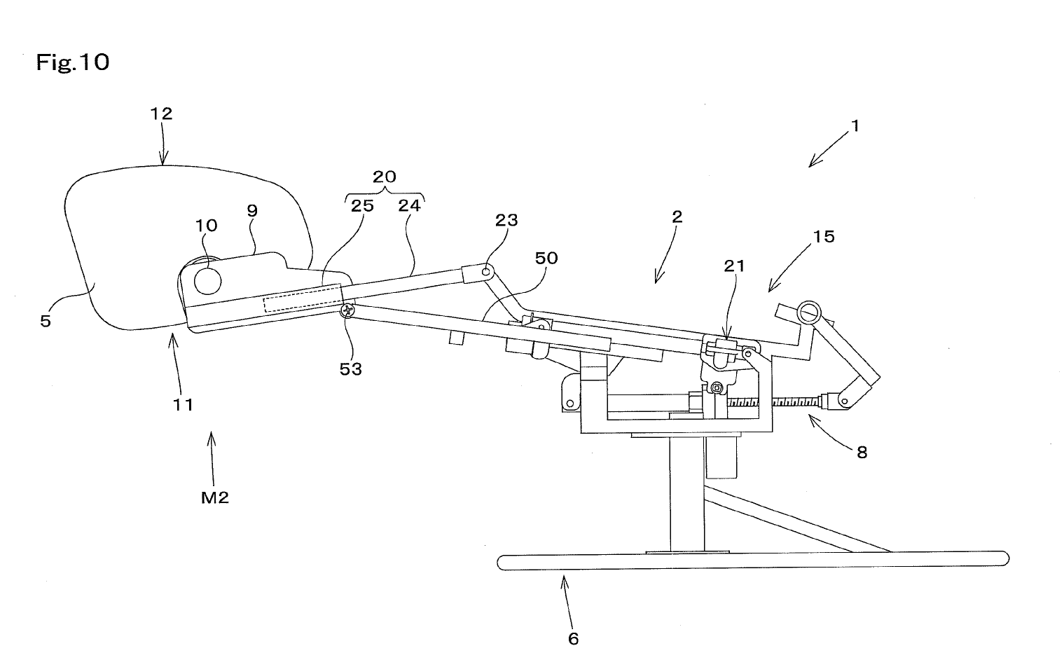

When in the massaging mode, the leg massaging device 5 can take: a zero position MO (zeroth position) in which the leg massaging device 5 hangs down in a state of making it possible to massage the lower limbs of a user while being supported at the front end of the seat section as shown in FIG. 8; a first massaging position M1 (first position) in which the leg massaging device 5 is moved to a state of inclining obliquely downward in front of the seat section so as to be able to massage the lower limbs of a user while being supported as shown in FIG. 9; and a second massaging position M2 (second position) in which the leg massaging device 5 is moved to a substantially horizontal state of being coplanar with the top surface in height of the seat section in front of the seat section and thereafter further advanced to be able to massage the lower limbs of a user while being supported as shown in FIG. 10. The leg massaging device 5 is made movable among the respective positions (M0 to M2).

The first massaging position M1 is set as an optional position (optional floating height from a floor surface) between the zero position MO and the second massaging position M2 by a user as occasion requires, or to be initialized by a user, an installer, a manager and the like in a stage of starting usage or a stage of shipping from a factory.

The movement of the leg massaging device 5 among the positions as mentioned above is performed by an advancing and retreating mechanism 15 provided in the chair-type massaging machine 1.

In specific, the advancing and retreating mechanism 15 is provided beneath the seat section 2, and the side of the seat section 2 (leg frame 6) and the leg massaging device 5 are coupled via the advancing and retreating mechanism 15. As described before, the leg massaging device 5 is coupled to the advancing and retreating mechanism 15 in a state that the supporting surface 11 and the treating surface 12 can be reversible back and forth.

As shown in FIGS. 1 to 10, the advancing and retreating mechanism 15 is provided with an expansion link 20.

A pair of the right and left expansion links 20 (two expansion links) are provided in a manner of coupling between a pair of right and left supporting members 9 for holding the leg massaging device 5 and fixed pivot parts 23 provided at the front end portion of the seat section 2 (a position protruded forward obliquely upward from the front end of the leg frame 6).

The expansion link 20 is a combination of a link main body 24 and a slide link 25. The slide link 25 is formed as an external cylinder shaft and the link main body 24 is formed as a solid-core or hollow inner shaft which is internally fitted to the slide link 25 (external cylinder shaft) in a manner of being slidable. It is noted that the link main body 24 may be formed as an external cylinder shat and the slide link 25 may be formed as an inner shaft.

The proximal end portion of the link main body 24 is coupled to the fixed pivot part 23 and the slide link 25 is fixed to the supporting member 9. This fixed pivot part 23 holds the expansion link 20 relatively pivotably about a pivotal shaft with its shaft center aligned in a lateral direction. Therefore, the expansion link 20 and the supporting member 9 (i.e., entire leg massaging device 5) can be swung back and forth with this fixed pivot part 23 as a fulcrum.

In addition, the expansion link 20 can be swung back and forth with the fixed pivot part 23 as a pivotal axis corresponding to a movement range of the leg massaging device 5 moving “from the stand-by position RO to the second reclining position R2” and “from the zero position M0 to the second massaging position M2”.

The advancing and retreating mechanism 15 is provided with a driving part 21. This driving part 21 is adapted to provide a driving force for swinging back and forth to the expansion link 20 or the supporting member 9 and includes a rail part 47, a back-and-forth moving part 48 and a prime mover mechanism 49.

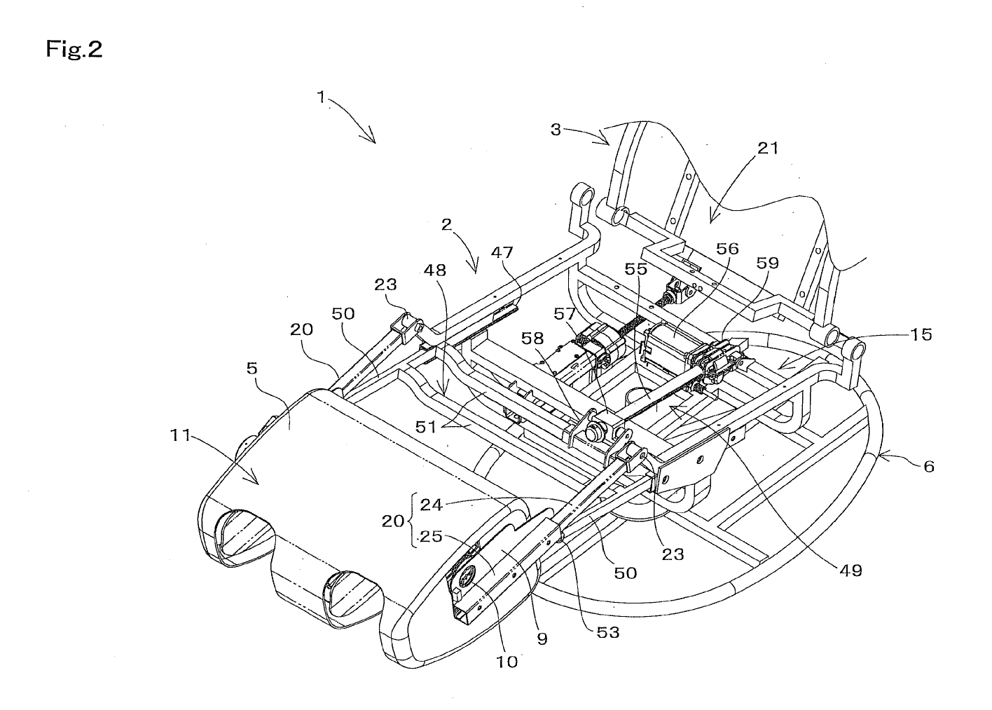

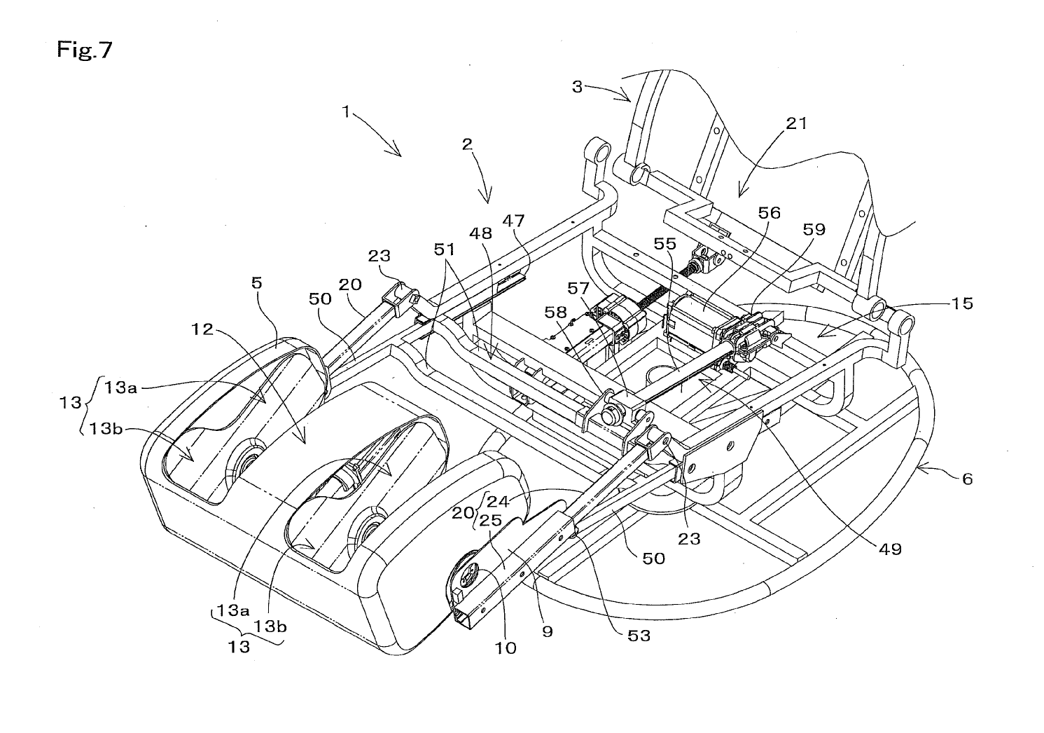

As shown in FIGS. 2 and 7, the paired right and left rail parts 47 (two rail parts) are provided in a state that the rail parts 47 are arranged in parallel to each other with their longitudinal direction aligned back and forth under the seat section 2 (upper side within the leg frame 6). In an example shown in the drawings, by attaching groove shaped thread screw members each having a U-character shape in sectional view in a manner that openings of the grooves are directed inward in a lateral direction (so as to be opposed between the two rail parts 47), each of the rail surfaces is formed with an opening inner surface of the groove.

The back-and-forth moving part 48 is held along the rail parts 47 in a manner of being movable back and forth so as to move in the back and forth direction under the seat section 2 (upper side within the leg frame 6). In the present embodiment, since the paired right and left rail parts 47 are provided with a prescribed space therebetween, the back-and-forth moving part 48 includes right and left slider contacts 50 engaged with the right and left rail parts 47 and a connecting member 51 for mutually coupling these slider contacts 50 therebetween.

The slider contacts 50 are formed in squared corner pipe shapes with their longitudinal directions aligned in the back and forth direction so as to be internally fitted to the rail parts 47 in a manner of smoothly slidable without a backlash. Each of the front end portions of these right and left slider contacts 50 is coupled to the supporting member 9 (or the slide link 25 of the expansion link 20) with the pivotal fulcrum 53. This pivotal fulcrum 53 holds the supporting member 9 in a manner of being relatively pivotable about the pivotal shaft with its shaft center aligned in the lateral direction.

The fixed pivot part 23 is provided at a height substantially coplanar with the top surface of the seat section 2 and the pivotal fulcrum 53 is arranged in a position lower than that of the fixed pivot part 23. In the stand-by position RO and the zero position M0, the pivotal fulcrum 53 is arranged at a position vertically lower than the fixed pivot part 23. Hence, the fixed pivot part 23 is naturally positioned higher than the pivotal fulcrum 53.

Further, the connecting member 51 is formed in a manner that two squared pipes with their longitudinal direction aligned in a lateral direction are provided in parallel with a prescribed space in a back and forth direction.

The prime mover mechanism 49 is adapted to provide the back-and-forth moving part 48 with a back-and-forth driving force and includes a feed screw shaft 55 provided in parallel to the rail parts 47, an electric motor 56 for rotating this feed screw shaft 55 and a nut part 57 externally fitted to the feed screw shaft 55 in a screwed state. This nut part 57 is attached onto the top portion of the connecting member 51 of the back-and-forth moving part 48 via a bracket 58.

A decelerator 59 is coupled to the electric motor 56, and this decelerator 59 is adapted to output an input from the electric motor 56 in a perpendicular direction in plan view, and this results in that the electric motor 56 is placed in a lateral arrangement state with respect to the feed screw shaft 55. Thus, a compact arrangement in a back and forth direction becomes possible for the prime mover mechanism 49.

The expansion link 20 is configured to have an expansion stroke necessary for further pushing the leg massaging device 5 forward when the supporting member 9 is swung forward with the fixed pivot part 23 as a pivotal fulcrum, while the supporting member 9 is kept in a substantially horizontal state.

The following describes an operating aspect of the chair-type massaging machine 1 having a configuration described above, in particular, an operation of the advancing and retreating mechanism 15.

First, the reclining mode time is described.

It is assumed that the leg massaging device 5 is kept in a state of positioning in the stand-by position RO where the leg massaging device 5 hangs down at the front end of the seat section as shown in FIG. 3. At this time, the leg massaging device 5 is kept in a state that, while the supporting surface 11 is facing forward, the lower limbs of a user are not supported (in a state that the leg massaging device 5 does not hinder a user), and the treating surface 12 (a surface provided with the holding grooves 13 into which the lower limbs of a user are fitted) is facing backward.

When the electric motor 56 of the driving part 21 is actuated, the supporting member 9 and the expansion link 20 are pushed forward by the pivotal fulcrum 53 as the back-and-forth moving part 48 advances. Therefore, as shown in FIG. 4, the supporting member 9 and the expansion link 20 are rendered to swing forward with the fixed pivot part 23 as a pivotal fulcrum. Thus, the leg massaging device 5 swings in a direction advancing the lower end side thereof forward so as to be in a state of inclining obliquely downward in front of the seat section and reaches the first reclining position R1.

By stopping the driving part 21 in the first reclining position R1 depending on preference of a user, it is possible to use as a chair or a sofa while the lower limbs of the user are supported on the supporting surface 11 of the leg massaging device 5.

By actuating the electric motor 56 of the driving part 21 so as to swing the expansion link 20 further forward, the leg massaging device 5 moves to be in a substantially horizontal state while being coincident with the top surface of the seat section in height at the front portion of the seat section. Then, the slide link 25 begins to extend out of the link main body 24 in the expansion link 20, and accordingly the whole part of the leg massaging device 5 including the supporting member 9 is rendered to advance forward substantially in a horizontal state, and results in that the leg massaging device 5 reaches the second reclining position R2.

In this second reclining position R2, since the supporting surface 11 of the leg massaging device 5 becomes substantially coincident with the top surface of the seat section 2 in height level so as to be continuous in a substantially horizontal state, a user is allowed to have a comfortable time in a relaxed posture such as stretching out the lower limbs onto the supporting surface 11.

A series of these operations are the advancing operation of the advancing and retreating mechanism 15.

Meanwhile, in the case where the electric motor 56 of the driving part 21 is reversely actuated from the second reclining position R2 with respect to the above operation, the expansion link 20 is moved in a manner of being retracted with the pivotal fulcrum 53 as the back-and-forth moving part 48 retreats so that the slide link 25 is contracted with respect to the link main body 24. Further, the expansion link 20 and the supporting member 9 accompanying the leg massaging device 5 are rendered to swing backward with the fixed pivot part 23 as a pivotal fulcrum. Then, the leg massaging device 5 moves to the stand-by position RO via the first reclining position R1.

A series of these operations are the retreating operation of the advancing and retreating mechanism 15. When the leg massaging device 5 returns to the stand-by position R0, the supporting surface 11 becomes in a state that the supporting surface 11 faces forward and does not protrude from the front end portion of the seat section 2, and therefore “a user who does not have a massage” sitting on the chair-type massaging machine 1 can keep a relaxed posture, and also an appearance of the chair-type massaging machine 1 can be made simple.

Next, the massaging mode time is described.

In addition, the switching from the reclining mode to the massaging mode is performed by manually operating a rotation angle retaining device 12 provided on the supporting member 9 by a user so as to reverse the leg massaging device 5 when the leg massaging device 5 is positioned in the first reclining position R1.

The following description is continued assuming that the leg massaging device 5 is currently in a state of positioning in the zero position M0 where the leg massaging device 5 hangs down at the front end of the seat section (i.e., in a state of having already been switched to the massaging mode) as shown in FIG. 8. At this time, the treating surface 12 (the surface provided with the holding grooves 13 into which the lower limbs of a user are fitted) of the leg massaging device 5 is facing forward and the supporting surface 11 is facing backward.

At this time, by actuating the lower limb massaging device 14 by a user in a state of fitting one by one foot in the right and left holding grooves 13 with respect to the leg massaging device 5, the user can have a massage comfortably while keeping the posture of sitting on the chair with the knees bent (posture of straightly putting down the lower limbs downward).

When the electric motor 56 of the driving part 21 is actuated, the supporting member 9 and the expansion link 20 are pushed forward by the pivotal fulcrum 53 as the back-and-forth moving part 48 advances. Therefore, as shown in FIG. 9, the supporting member 9 and the expansion link 20 becomes to swing forward with the fixed pivot part 23 as the pivotal fulcrum. Thus, the leg massaging device 5 swings in the direction of advancing the lower end side thereof forward so as to be in a state of inclining obliquely downward in front of the seat section and reaches the first massaging position M1.

By stopping the driving part 21 in the first massaging position M1 depending on preference of a user and actuating the lower limb massaging device 14 in addition, a user can have a massage comfortably with the bending condition (bending angle) of the knees kept loosely and taking a posture of slightly stretching out the lower limbs (posture of having a mild reclining).

By actuating the electric motor 56 of the driving part 21 so as to swing the expansion link 20 further forward, the leg massaging device 5 moves to be in a substantially horizontal state while being coincident with the top surface of the seat section in height at the front portion of the seat section. Then, in the case where the actuation of the driving part 21 is continued, the slide link 25 begins to extend out of the link main body 24 in the expansion link 20, and accordingly the whole part of the leg massaging device 5 including the supporting member 9 is rendered to advance forward substantially in a horizontal state, and results in that the leg massaging device 5 reaches the second massaging position M2.

In this second massaging position M2, the treating surface 12 (a level corresponding to a groove bottom within the holding groove 13) of the leg massaging device 5 becomes substantially coincident with the top surface of the seat section 2 in height level so as to be continuous in a substantially horizontal state. By actuating the lower limb massaging device 14 in addition, a user is allowed to have a massage comfortably while having a comfortable time in a relaxed posture such as stretching out the lower limbs onto the treating surface 12.

A series of these operations are the advancing operation of the advancing and retreating mechanism 15.

Meanwhile, in the case where the electric motor 56 of the driving part 21 is reversely actuated from the second massaging position M2 with respect to the above operation, the expansion link 20 is moved in a manner of being retracted with the pivotal fulcrum 53 as the back-and-forth moving part 48 retreats so that the slide link 25 is contracted with respect to the link main body 24. Further, the expansion link 20 and the supporting member 9 accompanying the leg massaging device 5 are rendered to swing backward with the fixed pivot part 23 as a pivotal fulcrum. Then, the leg massaging device 5 moves to the zero position M0 via the first massaging position M1.

A series of these operations are the retreating operation of the advancing and retreating mechanism 15.

By the way, the lower limb massaging device 14 built in leg massaging device 5 mentioned above is adapted to have a configuration of providing a massage by laterally swinging a long plate member provided within the holding groove 13.

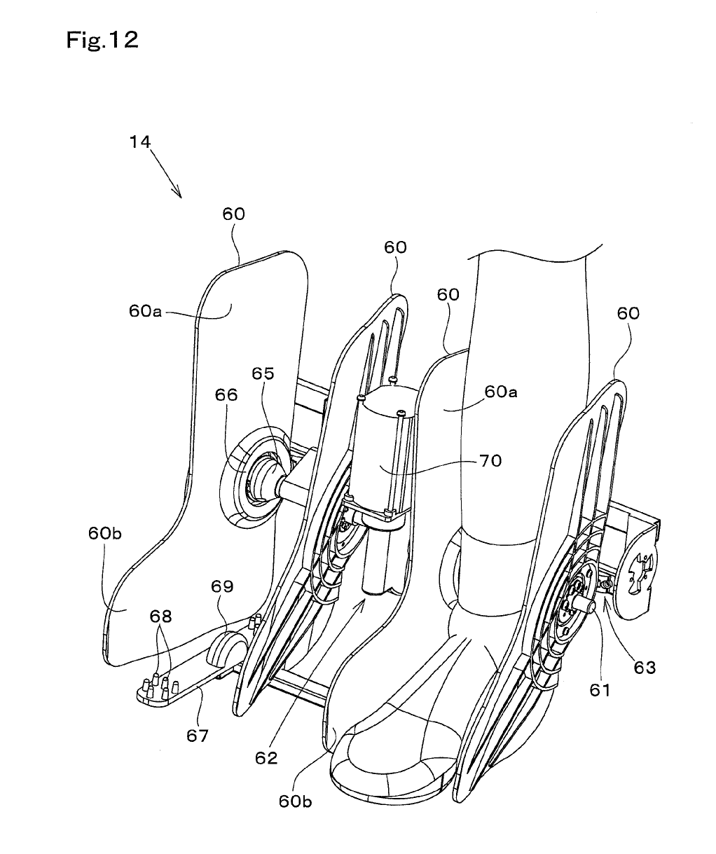

In specific, as shown in FIG. 12, it is configured to includes: a pair of right and left massaging members 60 and 60 provided in positioning of sandwiching the lower limbs from both of the right and left sides with respect to the lower limbs of a user; a single rotation shaft 61 penetrating these massaging members 60 and 60 in a skewering manner; a driving mechanism 62 for rotating the rotation shaft 61; and rotation regulating means 63 preventing the massaging members 60 from co-rotating at the time of rotating the rotation shaft 61.

Each of the massaging member 60 is formed in a boot shape (boot form) including a vertically elongated plate shape portion 60a corresponding to a calf and a back-and-forth elongated plate shape portion 60b corresponding to a foot portion and is formed of an elastic body such as a plastic or plate spring.

Around a portion of the rotation shaft 61 penetrating the massaging member 60, there are provided a fixing boss 65 that is integrally rotatable and inclines with respect to a shaft center of this rotation shaft 61 and a rotation tool 66 that is relatively rotatable around the fixing boss 65. This rotation tool 66 is fitted and fixed to a substantially center portion of the massaging member 60 in the vertical direction.

In addition, in the massaging members 60 having a mutually paired relation, the inclining directions of the fixing bosses 65 with respect to the rotation shaft 61 are made relatively opposite to each other. Therefore, the massaging members 60 having a mutually paired relation are in a relationship such that, when the upper end portions are mutually close, the lower end portions are mutually separated and that, when the upper end portions are mutually separated, the lower end portions are mutually close.

A back-and-forth elongated footrest 67 is provided between the lower portions of the massaging members 60 having a mutually paired relation, and this footrest 67 is provided with acupressure protrusions 68 and an arch massage roller 69 and the like.

The rotation regulating means 63 is configured such that an engagement shaft provided in a manner of protruding backward from the rear end of the massaging member 60 is held in engagement in a manner of allowing only a horizontal movement in a lateral direction.

Thus, when the driving mechanism 62 is actuated (a driving motor 70 is rotated), with the rotation of the rotation shaft 61, the massaging members 60 are operated in a manner that, when the upper end portions thereof are mutually close, the lower end portions thereof are mutually separated and, then, when the upper end portions are started to be mutually separated, the lower end portions are started to be mutually brought closer. Since the massaging members 60 are held in a state that it is not co-rotated with the rotation shaft 61 by the rotation regulating means 63, the massaging members 60 are rendered to repeat the operations of bringing closer and separation the upper and lower ends in a relatively reverse directions as described above, and this leads to a state that the calves and foot portions are alternately massaged.

In the lower limb massaging device 14 configured as described above, since the rotation shaft 61 is provided merely one and the driving mechanism 62 can be assembled as one unit, there can be obtained a vertically compacted configuration. Therefore, as described above, the leg massaging device 5 can be held in a floating state from the floor in the stand-by position R0 in the reclining mode time and the zero position M0 in the massaging mode time, and, particularly in the stand-by position R0, it becomes possible to surely accommodate the leg massaging device 5 beneath the front portion of the seat section 2.

In the above description, it should be considered that the present embodiments disclosed this time are exemplified ones but not limited ones in every viewpoint. The scope of the present invention is not defined by the above description but defined by the scope of the claims and it is intended to include the scope of the claims, meanings of the equivalents thereof and all of the modifications within a range of the scope.

### DESCRIPTION OF REFERENCE SYMBOLS

1 . . . Chair-type massaging machine

2 . . . Seat section

3 . . . Backrest part

5 . . . Leg massaging device

15 . . . Advancing and retreating mechanism

14 . . . Lower limb massaging device

20 . . . Expansion link

21 . . . Driving part

23 . . . Fixed pivot part

47 . . . Rail part

48 . . . Back-and-forth moving part

49 . . . Prime mover mechanism

50 . . . Slider contact

51 . . . Connecting member

53 . . . Pivotal fulcrum

55 . . . Feed screw shaft

56 . . . Electric motor

57 . . . Nut portion

1. A chair-type massaging machine provided with a leg massaging device comprising: a seat section; a backrest part provided at a rear portion of said seat section; and the leg massaging device provided at a front portion of said seat section, wherein
an advancing and retreating mechanism connected with said leg massaging device is provided beneath said seat section, wherein
said advancing and retreating mechanism is configured to advance said leg massaging device positioned in a zeroth position where said leg massaging device is in a state of hanging down in front of said seat section to a first position where said leg massaging device is in a state of inclining obliquely downward in front of said seat section and further advance said leg massaging device positioned in the first position to a second position where said leg massaging device is moved to be protruded forward so as to be in a substantially horizontal state while being coplanar with a top surface in height of said seat section, and wherein
said advancing and retreating mechanism lowers said leg massaging device positioned in the second position to return to the first position by retreat movement, and further lowers said leg massaging device positioned in the first position to return to the zeroth position.

2. The chair-type massaging machine provided with the leg massaging device according to claim 1, wherein said leg massaging device is provided with a supporting surface for supporting lower limbs of a user from a back side and a treating surface allowing to massage the lower limbs of the user so that the supporting surface and treating surface are located opposite in back-and-forth directions, and said supporting surface and treating surface are coupled to said advancing and retreating mechanism in a back-and-forth reversible state, and wherein
in a reclining mode in which the supporting surface of said leg massaging device is facing forward, said zeroth position is used as a stand-by position where said leg massaging device hangs down in a state that the lower limbs of the user are not supported, said first position is used as a first reclining position where the lower limbs of the user can be supported, and said second position is used as a second reclining position where the lower limbs of the user can be supported.

3. The chair-type massaging machine provided with the leg massaging device according to claim 1, wherein said leg massaging device is provided with a supporting surface for supporting lower limbs of a user from a back side and a treating surface allowing to massage the lower limbs of the user so that the supporting surface and treating surface are located opposite in back-and-forth directions, and said supporting surface and treating surface are coupled to said advancing and retreating mechanism in a back-and-forth reversible state, and wherein
in a massaging mode in which the treating surface of said leg massaging device is facing forward, said zeroth position is used as a zero position where said leg massaging device hangs down in a state that the lower limbs of the user can be massaged, said first position is used as a first massaging position where the lower limbs of the user can be massaged, and said second position is used as a second massaging position where the lower limbs of the user can be massaged.

4. The chair-type massaging machine provided with the leg massaging device according to claim 2, wherein, in said stand-by position, said leg massaging device is held on the front portion of said seat section in a state that a lower end portion of said leg massaging device floats up from a floor surface.

5. The chair-type massaging machine provided with the leg massaging device according to claim 1, wherein said advancing and retreating mechanism comprises:
a supporting member for holding said leg massaging device;
an expansion link having a proximal end side thereof provided at the front end portion of said seat section and coupled to a fixed pivot part freely pivotable about a lateral axis and a distal end side thereof attached to said supporting member so that said expansion link is extendable and contractable in a longitudinal direction; and
a driving part adapted to provide said expansion link with a swing about said fixed pivot part.

6. The chair-type massaging machine provided with the leg massaging device according to claim 5, wherein said driving part includes: rail parts provided under said seat section with the longitudinal direction thereof directed back and forth; a back-and-forth moving part movable back and forth along said rail parts; and a prime mover mechanism adapted to provide said back-and-forth moving part with a back-and-forth driving force, wherein
said back-and-forth moving part and said supporting member are coupled with each other with a pivotal fulcrum located beneath said fixed pivot part.

7. The chair-type massaging machine provided with the leg massaging device according to claim 6, wherein said fixed pivot part is provided substantially coplanar in height with a top surface of said seat section, and said pivotal fulcrum is located in a position substantially vertically beneath said fixed pivot part in said stand-by position or said zero position.

8. The chair-type massaging machine provided with the leg massaging device according to claim 7, wherein said rail parts are provided at both right and left sides under said seat section, and said back-and-forth moving part includes a pair of slider contacts engaged with said right and left rail parts and a connecting member for coupling between said pair of slider contacts, and wherein said expansion link or said supporting member is respectively coupled to the front end portion of each of said slider contacts with said pivotal fulcrum.

9. The chair-type massaging machine provided with the leg massaging device according to claim 8, wherein said expansion link of said advancing and retreating mechanism includes a link main body which is provided with said fixed pivot part at the proximal end thereof so as to be swingable and a slide link which is slidably held with respect to said link main body and fixed to said supporting member so as to have a structure extendable and contractable in the back and forth direction.

10. The chair-type massaging machine provided with the leg massaging device according to claim 9, wherein one of said link main body and said slide link of said expansion link is configured as an external cylinder shaft and the other is configured as an inner shaft which is internally fitted to said external cylinder shaft and is slidably movable in and out of said external cylinder shaft.

11. The chair-type massaging machine provided with the leg massaging device according to claim 3, wherein said leg massaging device is equipped with a built-in lower limb massaging device, and said lower limb massaging device includes: a pair of right and left massaging members formed in a boots shape in a side view along the lower limbs continually ranging from calves to foot portions of the user and arranged so as to hold the lower limbs therein and directed to said treating surface side; a single rotation shaft provided in a manner of transversely penetrating said pair of massaging member; a driving part for rotating said rotation shaft; and a conversion part for converting a rotating force of said rotation shaft to a massaging operation performed by said massaging members.

12. The chair-type massaging machine provided with the leg massaging device according to claim 3, wherein, in said zero position, said leg massaging device is held on the front portion of said seat section in a state that a lower end portion of said leg massaging device floats up from a floor surface.
